(19) United States
(12) Patent Application Publication
(10) Pub. No.: US 2014/0083241 A1
(43) Pub. Date: Mar. 27, 2014

(54) BURST COVER FOR A DAMPER

(71) Applicant: SCHAEFFLER TECHNOLOGIES AG & CO. KG, Herzogenaurach (DE)

(72) Inventor: Michael J. Hodge, Creston, OH (US)

(73) Assignee: SCHAEFFLER TECHNOLOGIES AG & CO. KG, Herzogenaurach (DE)

(21) Appl. No.: 13/968,753

(22) Filed: Aug. 16, 2013

Related U.S. Application Data
(60) Provisional application No. 61/704,141, filed on Sep. 21, 2012.

(51) Int. Cl. F16F 15/30

(52) U.S. Cl. CPC F16F 15/30
USPC 74/572.21

(57) ABSTRACT

A burst cover for a damper includes a plurality of holes arranged for fixing the cover to a flywheel, at least one tab portion arranged for drivingly connecting to a tab for a flange of the damper, and a radial wall connecting the plurality of holes to the at least one tab portion. In an example embodiment, the burst cover includes a plurality of depressed portions axially offset from the radial wall. Each of the plurality of holes are disposed in one of the depressed portions. In an example embodiment, the at least one tab portion extends axially from the radial wall. In some example embodiments, the burst cover includes an axially extending rim portion disposed radially outside of the plurality of holes. In an example embodiment, the burst cover is a continuous piece of material from the at least one tab portion to the rim portion that is devoid of any openings except for the plurality of holes arranged for fixing the burst cover to the flywheel.

### FIELD

The invention relates generally to a damper, and more specifically to a burst cover for a damper.

### BACKGROUND

Dampers are known. One example is shown in U.S. Pat. No. 8,092,266 to Okabe for a Marine Vessel Propulsion Unit. Another example may be found in commonly assigned German Patent Application Publication No. 10 2010 054 304 A1.

### BRIEF SUMMARY

Example aspects broadly comprise a burst cover for a damper. The burst cover has a plurality of holes arranged for fixing the cover to a flywheel, at least one tab portion arranged for drivingly connecting to a tab for a flange of the damper, and a radial wall connecting the plurality of holes to the at least one tab portion. In an example embodiment, the burst cover includes a plurality of depressed portions axially offset from the radial wall. Each of the plurality of holes are disposed in one of the depressed portions. In an example embodiment, the at least one tab portion extends axially from the radial wall. In some example embodiments, the burst cover includes an axially extending rim portion disposed radially outside of the plurality of holes. In an example embodiment, the burst cover is a continuous piece of material from the at least one tab portion to the rim portion that is devoid of any openings except for the plurality of holes arranged for fixing the burst cover to the flywheel.

Other example aspects broadly comprise a flywheel assembly for connecting a engine with a transmission. The assembly includes a flywheel arranged for connecting to the engine, a damper with a flange arranged for connecting to the transmission and including a first tab portion, and a cover fixed to the flywheel and including a second tab portion arranged for driving engagement with the first tab portion in the event of a damper component failure. In an example embodiment, the first tab portion protrudes in a radial direction and the second tab portion protrudes in an axial direction. In an example embodiment, the cover includes a plurality of depressed portions with holes arranged for fixing the cover to the flywheel. In an example embodiment, the flange includes a tubular portion with a spline for connecting to the input shaft.

In some example embodiments, the flywheel assembly includes a mounting spring fixed to the flywheel, and a first cover plate fixed to the mounting spring. In some example embodiments, the first cover plate includes a first outer circumferential surface and the cover includes an inner circumferential surface disposed proximate the first cover plate outer circumferential surface. In an example embodiment, the first outer circumferential surface includes a first radius, the first tab portion includes a second outer circumferential surface with a second radius, and the second radius is greater than the first radius.

In some example embodiments, the flywheel assembly includes a second cover plate fixed to the first cover plate and a plurality of spring elements disposed axially between the first and second cover plates. In an example embodiment, the second cover plate is fixed to the first cover plate by a spacer bolt, the spring elements each include a solid height, and the flange includes a third tab portion radially inside of the first tab portion. During operation of the damper, the third tab portion is arranged to contact the spacer bolt for a spring height greater than the solid height. In some example embodiments, the flange is disposed axially between the first and second cover plates and the spring elements are for torque transmission between the flange and the first and second cover plates. In an example embodiment, the first and second tab portions are arranged for driving engagement in case of a failure of the mounting spring, and/or at least one of the first or second cover plates.

Other example aspects broadly comprise a torque transmission assembly arranged for connecting an engine to a transmission. The torque transmission assembly includes a first torque transmission path from a flywheel through a mounting spring, cover plate, and at least one spring element, to a flange. The torque transmission assembly also includes a second torque transmission path, parallel to the first transmission path, from the flywheel through a cover to the flange. In an example embodiment, the first and second torque transmission paths do not transmit torque concurrently. In an example embodiment, the second torque transmission path transmits torque only when an element of the first torque transmission path fails.

### BRIEF DESCRIPTION OF THE DRAWINGS

The nature and mode of operation of the present invention will now be more fully described in the following detailed description taken with the accompanying drawing figures, in which:

FIG. 1A is a perspective view of a cylindrical coordinate system demonstrating spatial terminology used in the present application;

FIG. 1B is a perspective view of an object in the cylindrical coordinate system of FIG. 1A demonstrating spatial terminology used in the present application;

FIG. 2 is a perspective view of a flywheel assembly according to an example aspect;

FIG. 3 is a perspective exploded view of the flywheel assembly of FIG. 2;

FIG. 4 is a front view of a burst cover;

FIG. 5 is a front view of a flange for a damper assembly; and,

FIG. 6 is a cross section view of the flywheel assembly of FIG. 2.

### DETAILED DESCRIPTION

At the outset, it should be appreciated that like drawing numbers appearing in different drawing views identify identical, or functionally similar, structural elements. Furthermore, it is understood that this invention is not limited only to the particular embodiments, methodology, materials and modifications described herein, and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein have the same meaning as commonly understood to one of ordinary skill in the art to which this invention belongs. Although any methods, devices or materials similar or equivalent to those described herein can be used in the practice or testing of the invention, the following example methods, devices, and materials are now described.

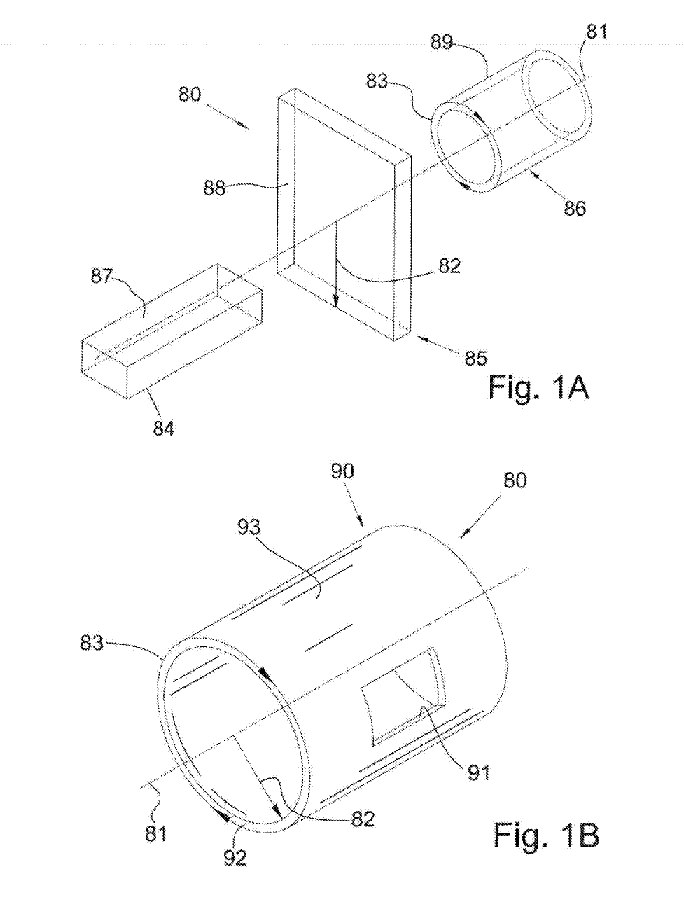

FIG. 1A is a perspective view of cylindrical coordinate system 80 demonstrating spatial terminology used in the present application. The present invention is at least partially described within the context of a cylindrical coordinate system. System 80 has a longitudinal axis 81, used as the reference for the directional and spatial terms that follow. The adjectives “axial,” “radial,” and “circumferential” are with respect to an orientation parallel to axis 81, radius 82 (which is orthogonal to axis 81), and circumference 83, respectively. The adjectives “axial,” “radial” and “circumferential” also are regarding orientation parallel to respective planes. To clarify the disposition of the various planes, objects 84, 85, and 86 are used. Surface 87 of object 84 forms an axial plane. That is, axis 81 forms a line along the surface. Surface 88 of object 85 forms a radial plane. That is, radius 82 forms a line along the surface. Surface 89 of object 86 forms a circumferential plane. That is, circumference 83 forms a line along the surface. As a further example, axial movement or disposition is parallel to axis 81, radial movement or disposition is parallel to radius 82, and circumferential movement or disposition is parallel to circumference 83. Rotation is with respect to axis 81.

The adverbs “axially,” “radially,” and “circumferentially” are with respect to an orientation parallel to axis 81, radius 82, or circumference 83, respectively. The adverbs “axially,” “radially,” and “circumferentially” also are regarding orientation parallel to respective planes.

FIG. 1B is a perspective view of object 90 in cylindrical coordinate system 80 of FIG. 1A demonstrating spatial terminology used in the present application. Cylindrical object 90 is representative of a cylindrical object in a cylindrical coordinate system and is not intended to limit the present invention in any manner. Object 90 includes axial surface 91, radial surface 92, and circumferential surface 93. Surface 91 is part of an axial plane, surface 92 is part of a radial plane, and surface 93 is part of a circumferential plane.

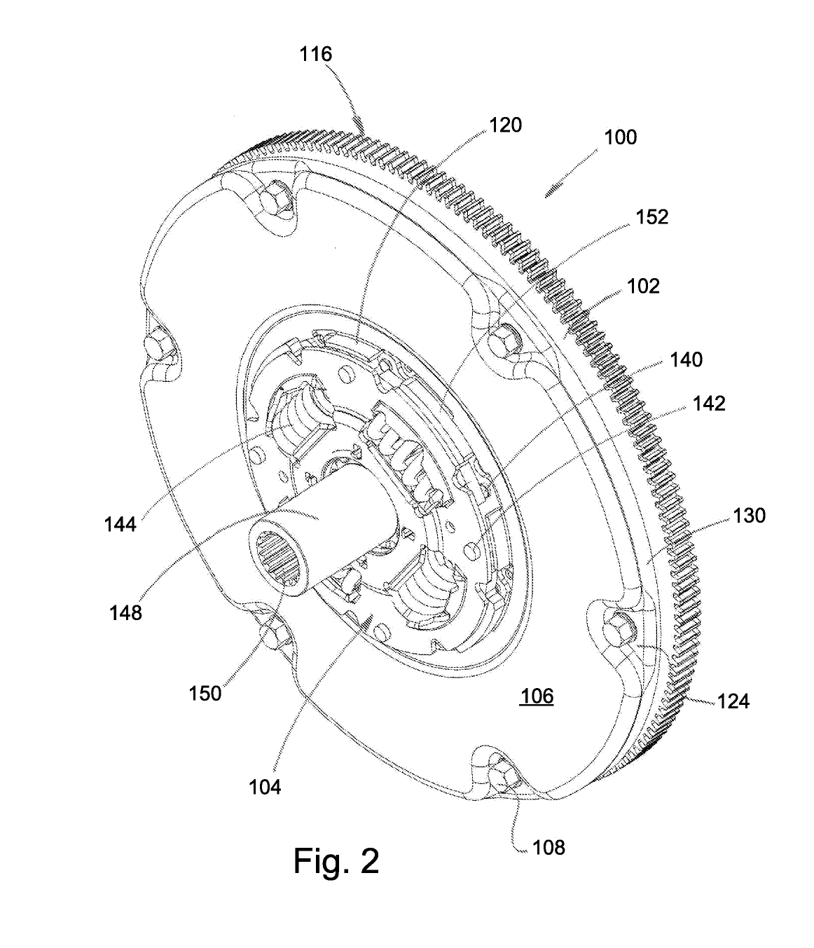

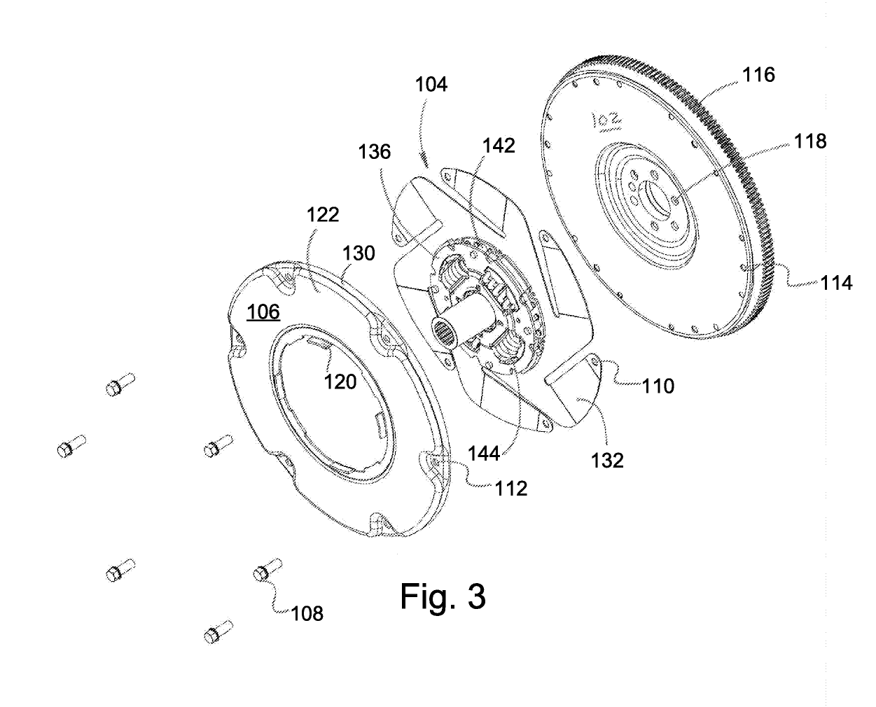

The following description is made with reference to FIGS. 2-3. FIG. 2 is a perspective view of flywheel assembly 100 according to an example aspect. FIG. 3 is a perspective exploded view of flywheel assembly 100 of FIG. 2. Flywheel assembly 100 includes flywheel 102, damper assembly 104 and burst cover 106. Assembly 104 and cover 106 are fixed to flywheel 102 by bolts 108 extending through respective apertures 110 and 112 in the damper assembly and burst cover, and fitted into threaded bores 114 in the flywheel. Flywheel 102 includes ring gear 116 for driving engagement with a starter motor, and mounting holes 118 for fixing the flywheel to a crankshaft of an engine as is commonly known in the art.

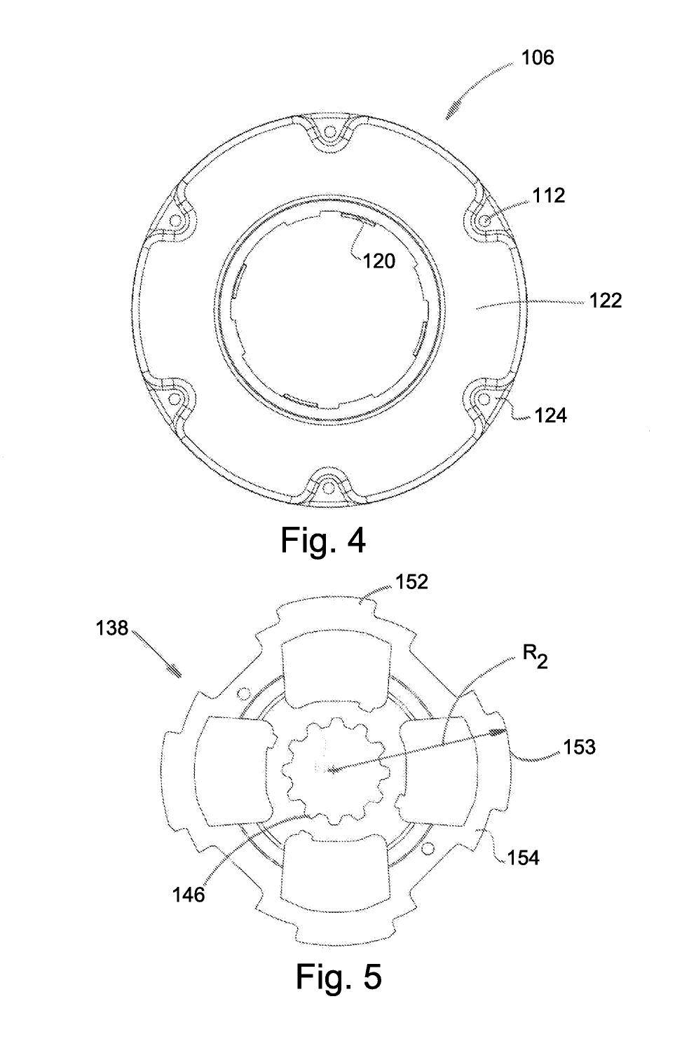

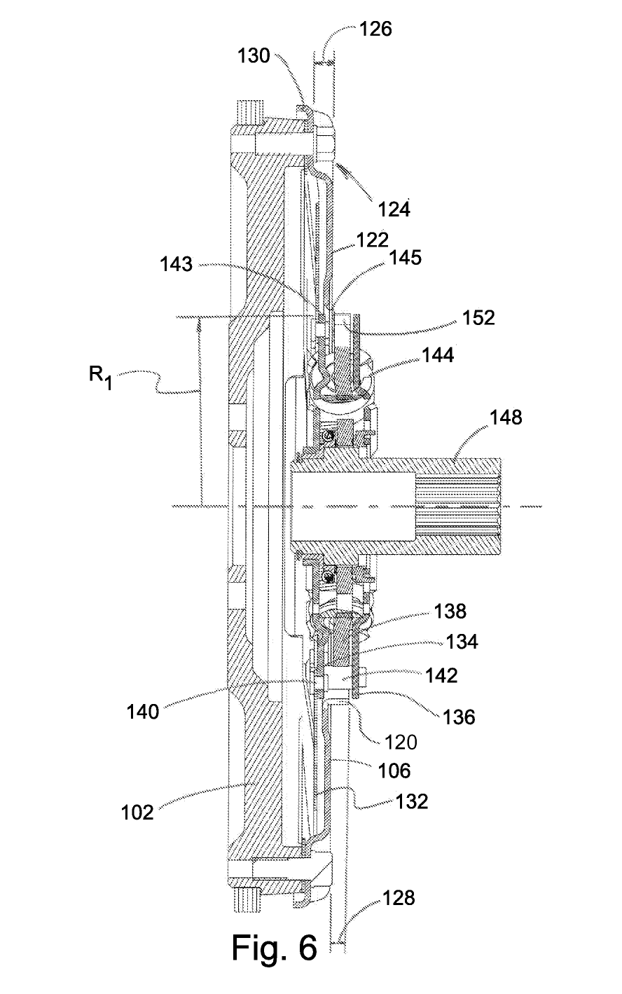

The following description is made with reference to FIGS. 2-6. FIG. 4 is a front view of burst cover 106. FIG. 5 is a front view of a flange for damper assembly 104. FIG. 6 is a cross section view of flywheel assembly 100 of FIG. 2. Burst cover 106 includes a plurality of holes 112 arranged for fixing the cover to the flywheel as described above. The cover also includes tab portion 120 arranged for drivingly connecting to a tab for a flange of damper assembly 104 as described below. Radial wall 122 connects holes 112 to tab portion 120. Cover 106 includes depressed portions 124 axially offset from radial wall 122 by distance 126 (ref. FIG. 6). Each of holes 112 are disposed in one of depressed portions 124.

Tab portion 120 extends axially from radial wall 122 by distance 128 (ref. FIG. 6). Cover 106 includes axially extending rim portion 130 disposed radially outside of holes 112. Burst cover 106 is a continuous piece of material from tab portion 120 to rim portion 130 that is devoid of openings except for holes 112 for fixing the burst cover to the flywheel. Therefore, when the burst cover is fixed to the flywheel, the damper is contained by the flywheel and the burst cover such that any failure of the damper components will be contained and pose less injury to the operator and/or vehicle. This containment function is similar to that performed by a transmission bellhousing. Some marine vehicles, such as boats with inboard/outboard drive systems, do not include a transmission bellhousing so the burst cover may be used to protect the operator and vehicle in the event of a damper component failure.

Damper assembly 104 includes mounting spring 132, cover plates 134 and 136, and flange 138 disposed axially between the cover plates. Plate 134 is fixed to spring 132 by rivets 140. Plate 136 is fixed to plate 134 by spacer bolts 142. Cover plate 134 includes outer circumferential surface 143 with radius R1. As best viewed in FIG. 6, surface 143 is disposed proximate inner circumferential surface 145 of burst cover 106. Flange 138 is drivingly connected to plates 134 and 136 by spring elements, or coil springs, 144. That is, spring elements 144 are for torque transmission between flange 138 and cover plates 134 and 136. Flange 138 includes spline 146 drivingly engaged with hub 148. Hub 148 includes tubular portion 150 with a spline for connecting to an input shaft of a transmission. In some example embodiments (not shown), flange 138 and hub 148 are integrally formed from a single piece of material.

Flange 138 includes radially protruding tab portion 152. Tab 152 includes outer circumferential surface 153 with radius R2 (see FIG. 5). In an example embodiment, R2 is greater than R1. Cover tab 120 is arranged for driving engagement with tab portion 152 in the event of a damper component failure. This is best shown in FIG. 2. Interaction of tabs 120 and 152 advantageously permits connection of the engine and transmission even in the event of damper failure. So, if any of spring 132, plates 134 or 136, rivets 140, spacer bolts 142, or springs 144, or any combination of these components, should fail, tabs 120 and 152 are arranged to directly connect the engine to the transmission through flywheel 102, cover 106, flange 138 and hub 148. This functionality provides an important “limp home” mode for marine vehicles, such as boats, when the operator could otherwise be stranded miles away from assistance.

Spring elements 144 each include a solid height. That is, when fully compressed, individual spring coils lay directly upon one another without any gap between the coils. In other words, the solid height is the height of the spring when it cannot be compressed any further. Individual coil stress at the solid height is generally high since the round coils pressing against one another tend to radially deflect the coils from a centerline of the spring in an unpredictable manner. Flange 138 includes tab portion 154 arranged to contact spacer bolt 142 for a spring height greater than the solid height. That is, in order to protect springs 144 from impacts and improve durability of the damper, torque which would normally compress the springs to a solid height is carried from plates 134 and 136 directly to flange 138 by contact between spacer bolt 142 and tab 154.

As described above, flywheel assembly, or torque transmission assembly, 100 includes two distinct torque transmission paths. A first path flows from flywheel 102 through mounting spring 132, cover plate 134, and spring element 144, to flange 138. A second path flows from flywheel 102 through cover 106 to flange 138. The second path is parallel to the first path but circumferential lengths of tabs 120 and 153 are selected such that, during torque flow through the first path, a circumferential gap exists between the tabs and the second torque path is inactive. As described above, should a damper component fail reducing or eliminating the torque flowing through the first torque path, the tabs are able to contact one another to transfer torque through the second torque path. For example, if a combination of spacer bolts 142 and springs 144 fail, flange 138 is able to rotate to a greater extent relative to cover plates 134 and 136, until a point when flange tab 153 contacts cover tab 120.

In an example embodiment, the first and separate torque transmission paths do not transmit torque concurrently. That is, the second torque path is only active when the first torque path transmits no torque. This situation may occur in the event of a complete failure of mounting spring 132. In this case, the first torque path is inactive but the second torque path connects the engine to the transmission, enabling the operator to “limp home”.

Although flywheel assembly 102 has been described for use in a marine vehicle, other applications may exist and should be considered within the scope of the invention. For example, the assembly may be useful for mining equipment or other machines or vehicles in remote locations or important to maintain operation, even in the event of component failure.

Of course, changes and modifications to the above examples of the invention should be readily apparent to those having ordinary skill in the art, without departing from the spirit or scope of the invention as claimed. Although the invention is described by reference to specific preferred and/or example embodiments, it is clear that variations can be made without departing from the scope or spirit of the invention as claimed.

What I claim is:

1. A burst cover for a damper comprising:
a plurality of holes arranged for fixing the cover to a flywheel;
at least one tab portion arranged for drivingly connecting to a tab for a flange of the damper; and,
a radial wall connecting the plurality of holes to the at least one tab portion.

2. The burst cover of claim 1 further comprising a plurality of depressed portions axially offset from the radial wall, wherein each of the plurality of holes are disposed in one of the depressed portions.

3. The burst cover of claim 1 wherein the at least one tab portion extends axially from the radial wall.

4. The burst cover of claim 1 further comprising an axially extending rim portion disposed radially outside of the plurality of holes.

5. The burst cover of claim 4 wherein the burst cover is a continuous piece of material from the at least one tab portion to the rim portion that is devoid of any openings except for the plurality of holes arranged for fixing the burst cover to the flywheel.

6. A flywheel assembly for connecting a engine with a transmission comprising:
a flywheel arranged for connecting to the engine;
a damper with a flange arranged for connecting to the transmission and including a first tab portion; and,
a cover fixed to the flywheel and including a second tab portion arranged for driving engagement with the first tab portion in the event of a damper component failure.

7. The flywheel assembly of claim 6 wherein the first tab portion protrudes in a radial direction and the second tab portion protrudes in an axial direction.

8. The flywheel assembly of claim 6 wherein the cover includes a plurality of depressed portions with holes arranged for fixing the cover to the flywheel.

9. The flywheel assembly of claim 6 wherein the flange includes a tubular portion with a spline for connecting to the input shaft.

10. The flywheel assembly of claim 6 further comprising:
a mounting spring fixed to the flywheel; and,
a first cover plate fixed to the mounting spring.

11. The flywheel assembly of claim 10 wherein:
the first cover plate includes a first outer circumferential surface; and,
the cover includes an inner circumferential surface disposed proximate the first cover plate outer circumferential surface.

12. The flywheel assembly of claim 11 wherein:
the first outer circumferential surface includes a first radius;
the first tab portion includes a second outer circumferential surface with a second radius; and,
the second radius is greater than the first radius.

13. The flywheel assembly of claim 10 further comprising:
a second cover plate fixed to the first cover plate; and,
a plurality of spring elements disposed axially between the first and second cover plates.

14. The flywheel assembly of claim 13 wherein:
the second cover plate is fixed to the first cover plate by a spacer bolt;
the spring elements each include a solid height; and,
the flange includes a third tab portion radially inside of the first tab portion; wherein
during operation of the damper, the third tab portion is arranged to contact the spacer bolt for a spring height greater than the solid height.

15. The flywheel assembly of claim 13 wherein:
the flange is disposed axially between the first and second cover plates; and,
the spring elements are for torque transmission between the flange and the first and second cover plates.

16. The flywheel assembly of claim 15 wherein the first and second tab portions are arranged for driving engagement in case of a failure of the mounting spring, and/or at least one of the first or second cover plates.

17. A torque transmission assembly arranged for connecting an engine to a transmission comprising:
a first torque transmission path from a flywheel through a mounting spring, cover plate, and at least one spring element, to a flange; and,
a second torque transmission path, parallel to the first transmission path, from the flywheel through a cover to the flange.

18. The torque transmission assembly of claim 16 wherein the first and second torque transmission paths do not transmit torque concurrently.

19. The torque transmission assembly of claim 17 wherein the second torque transmission path transmits torque only when an element of the first torque transmission path fails.
